(19) United States
(12) Patent Application Publication
(10) Pub. No.: US 2023/0163307 A1
(43) Pub. Date: May 25, 2023

(54) ANODE FOR LITHIUM SECONDARY BATTERY COMPRISING COMPOSITE

(71) Applicants: HYUNDAI MOTOR COMPANY, Seoul (KR); KIA CORPORATION, Seoul (KR)

(72) Inventors: Seung Jong Lee, Uiwang-si, Gyeonggi-do (KR); Seong Min Ha, Uiwang-si, Gyeonggi-do (KR); Jong Chang Song, Uiwang-si, Gyeonggi-do (KR); Jae Wook Shin, Uiwang-si, Gyeonggi-do (KR); Won Keun Kim, Uiwang-si, Gyeonggi-do (KR); Kyoung Han Ryu, Uiwang-si, Gyeonggi-do (KR)

(73) Assignees: Hyundai Motor Company, Seoul (KR); Kia Corporation, Seoul (KR)

(21) Appl. No.: 17/897,580

(22) Filed: Aug. 29, 2022

(30) Foreign Application Priority Data
Aug. 30, 2021 (KR) 10-2021-0114665

(51) Int. Cl. H01M 4/62; H01M 4/38; H01M 10/052

(52) U.S. Cl. CPC H01M 4/628; H01M 4/382; H01M 4/625; H01M 10/052; H01M 2004/027

(57) ABSTRACT

Disclosed is an anode for a lithium secondary battery including a composite including a structure and a lithium metal or lithium alloy with which the structure is filled.

### CROSS-REFERENCE TO RELATED APPLICATION

This application claims under 35 U.S.C. § 119(a) the benefit of priority from Korean Patent Application No. 10-2021-0114665, filed on Aug. 30, 2021, the entire contents of which are incorporated herein by reference.

### TECHNICAL FIELD

The present disclosure relates to an anode for a lithium secondary battery including a composite including a structure and a lithium metal or lithium alloy filled in the structure.

### BACKGROUND

The lithium secondary battery is the kind of secondary battery having the highest energy density among currently commercialized secondary batteries and is useful in various fields such as electric vehicles.

The anode of a commercial lithium secondary battery is formed of a graphite material. Although the graphite material has a theoretical capacity of 372 mAh/g, limitations are imposed on application thereof to electric vehicles and large-capacity energy storage systems requiring high energy density.

To support the development of next-generation secondary batteries such as lithium-sulfur batteries and lithium-air batteries, the capacity of commercial anodes is required to increase.

A lithium metal is receiving attention as an anode material capable of achieving high energy density because of a high theoretical capacity of 3860 mAh/g and a very low redox potential (−3.04V vs. S.H.E).

However, due to the high reactivity of alkali metals, side reactions thereof with the liquid electrolyte occur during battery operation.

Moreover, lithium foil is conventionally used as lithium metal, but there is the risk of an internal short circuit due to growth of lithium dendrites. Internal short circuits generate a lot of heat and sparks, which may be a major cause of battery fires and explosions.

### SUMMARY

An object of the present disclosure is to provide an anode for a lithium secondary battery capable of suppressing the growth of lithium dendrites and enabling uniform lithium plating and stripping.

The objects of the present disclosure are not limited to the foregoing. The objects of the present disclosure will be able to be clearly understood through the following description and to be realized by the means described in the claims and combinations thereof.

An embodiment of the present disclosure provides an anode for a lithium secondary battery including a composite including a structure having a predetermined shape by agglomerating a plurality of particles and a lithium metal or lithium alloy filled in a space between the particles in the structure.

The particles may include at least one of spherical particles, linear particles, sheet-type particles, or combinations thereof.

The particles may include at least one of carbon spheres, carbon fibers, carbon nanotubes, graphene, graphene oxide, reduced graphene oxide, carbon nitride, or combinations thereof.

The particles may include at least one of poly(3,4-ethylenedioxythiophene)-poly(styrenesulfonate) (PEDOT-PSS), polyacrylonitrile (PAN), poly(methyl methacrylate) (PMMA), poly(tetrafluoroethylene) (PTFE), poly(vinylidene fluoride) (PVDF), Nafion, cellulose and cellulose-based polymers, poly(ethylene oxide) (PEO), or combinations thereof.

The surface of the particles may be substituted with a functional group, wherein the functional group comprises at least one of a hydroxyl group, a carboxyl group, a carbonyl group, an ester group, an amide group, a nitrile group, or combinations thereof.

The size of the particles may range from about 400 nm to about 4 μm.

The lithium alloy may include an alloy of lithium and at least one of magnesium (Mg), silicon (Si), tin (Sn), aluminum (Al), germanium (Ge), bismuth (Bi), or antimony (Sb).

The size of the composite may range from about 400 nm to about 4 μm.

### BRIEF DESCRIPTION OF THE DRAWINGS

The above and other features of the present disclosure will now be described in detail with reference to certain exemplary embodiments thereof illustrated in the accompanying drawings, which are given hereinbelow by way of illustration only, and thus are not limitative of the present disclosure, and wherein:

FIG. 1 shows a cross-sectional view of a lithium secondary battery according to the present disclosure;

FIG. 2 shows an anode according to the present disclosure;

FIG. 3 shows a composite according to the present disclosure;

FIG. 4 shows a reference view for explaining plating of lithium onto the composite and stripping of lithium therefrom during charging and discharging of the lithium secondary battery according to the present disclosure;

FIG. 5 shows a reference view for explaining a change in the anode during charging and discharging of the lithium secondary battery according to the present disclosure;

FIG. 6A shows a scanning electron microscope (SEM) image of the shape of lithium plated on the anode according to Example of the present disclosure;

FIG. 6B shows an SEM image of the shape of lithium plated on the anode according to Comparative Example of the present disclosure; and

FIG. 7 shows the results of evaluation of the lifespan of the battery cells according to Example and Comparative Example of the present disclosure.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Whether or not modified by the term “about”, the claims include equivalents to the quantities. Unless otherwise stated or otherwise evident from the context, the term “about” may mean within XX% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used herein, the terms “about” and “approximately” are used as equivalents. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

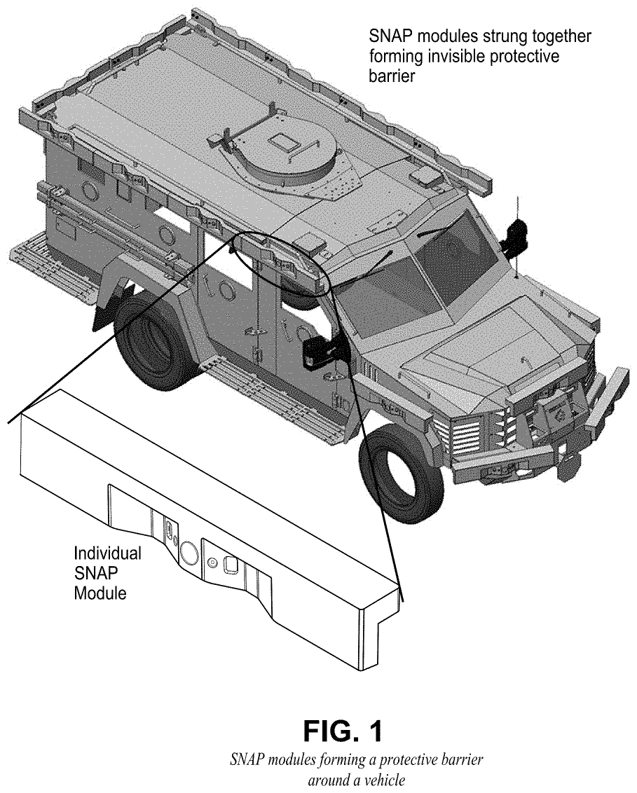

FIG. 1 shows a cross-sectional view of a lithium secondary battery according to the present disclosure. The lithium secondary battery may include an anode current collector 10, an anode 20, a separator 30, a cathode 40, and a cathode current collector 50, which are sequentially stacked.

The anode current collector 10 may be an electrically conductive plate-type substrate. The anode current collector 10 may include copper (Cu), nickel (Ni), stainless steel (SUS), or the like.

The anode current collector 10 may be a high-density metal thin film having porosity of less than about 1%.

The anode current collector 10 may have a thickness of about 1 μm to 20 μm, or about 5 μm to 15 μm.

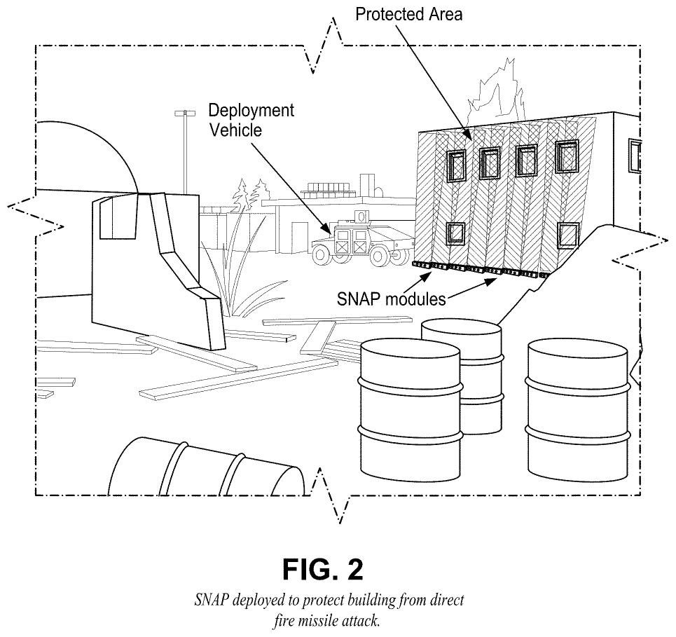

FIG. 2 specifically shows the anode 20. The anode 20 may include a plurality of composites 21 having a predetermined shape. The anode 20 may consists of the composites 21, as shown in FIG. 2, or may comprises a metal foam (not shown) filled with the composites 21 in order to maintain a layered shape.

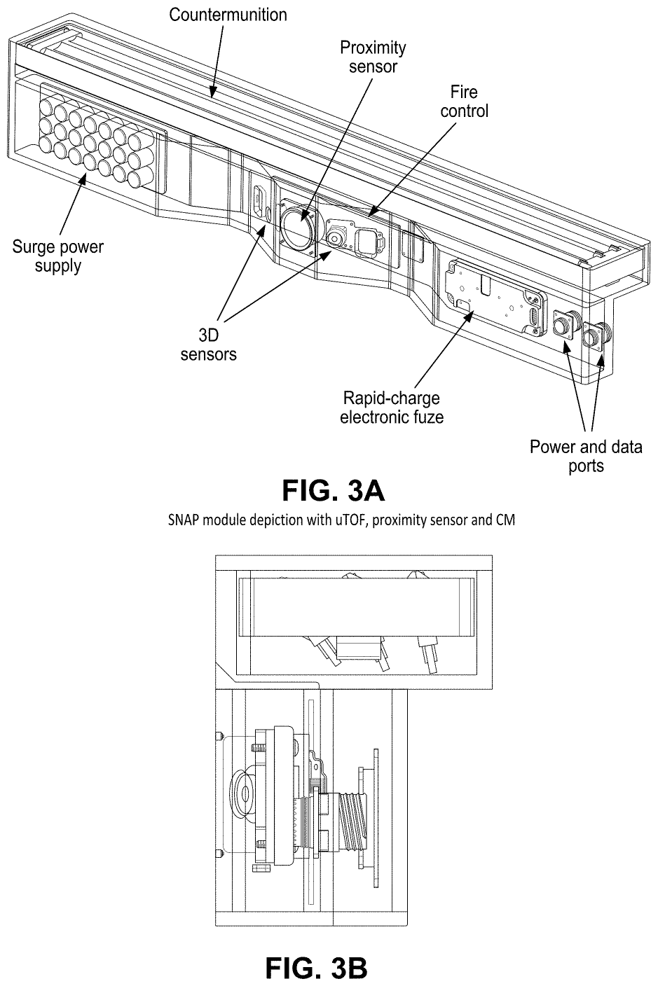

FIG. 3 shows the composite 21. The composite 21 may include a structure 211 having a predetermined shape by agglomerating a plurality of particles 211a and a lithium metal or lithium alloy 212 filled in the structure.

The size of the composite 21 is not particularly limited, but may be, for example, about 400 nm to about 4 μm.

Although the particles 211a are shown as being linear in FIG. 3, this linear shape is merely exemplary, and the particles 211a may include, but is not limited to, at least one of spherical particles, linear particles, sheet-type particles, or combinations thereof.

The particles 211a may include, but is not limited to, at least one of carbon spheres, carbon fibers, carbon nanotubes, graphene, graphene oxide, reduced graphene oxide, carbon nitride, or combinations thereof.

The particle 211a may include at least one of poly(3,4-ethylenedioxythiophene)-poly(styrenesulfonate) (PEDOT-PSS), polyacrylonitrile (PAN), or combinations thereof.

Meanwhile, the particles 211a may be agglomerated with each other to form the structure 211 such that a space is formed between adjacent particles 211a. Accordingly, as will be described later, a lithium metal or lithium alloy may fill the space between the particles 211a.

The surface of the particles 211a may be substituted with, but is not limited to, at least one functional group of a hydroxyl group, a carboxyl group, an epoxy group, or combinations thereof. Accordingly, the space between the particles 211a may be more easily filled with the lithium metal or lithium alloy.

The size of the particles 211a is not particularly limited, but may be, for example, about 400 nm to about 4 μm.

The lithium metal or lithium alloy may fill the space between the particles 211a in the structure 211.

The lithium alloy may be an alloy of lithium and at least one of magnesium (Mg), silicon (Si), tin (Sn), aluminum (Al), germanium (Ge), bismuth (Bi), or antimony (Sb).

The method of manufacturing the composite 21 is not particularly limited, and the particles 211a are agglomerated through a process such as spray drying or the like to obtain a structure 211 having a predetermined shape, and the structure is brought into contact with a molten lithium metal or lithium alloy 212 so that the lithium metal or lithium alloy 212 fills the structure 211. Here, the molten lithium metal or lithium alloy 212 is naturally drawn into the space in the structure 211 by a capillary phenomenon, and as described above, the capillary phenomenon may be facilitated by the functional group substituted on the surface of the particles 211a.

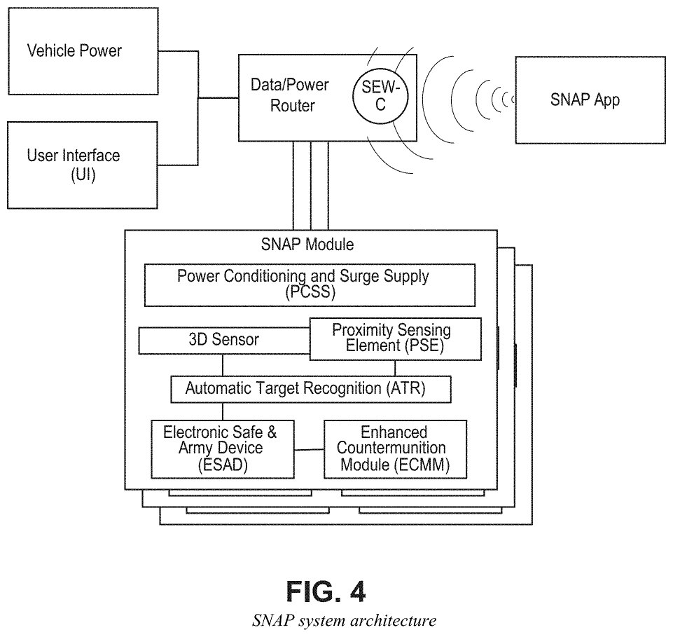

FIG. 4 shows a reference view for explaining plating of lithium onto the composite 21 and stripping of lithium therefrom during charging and discharging of the lithium secondary battery. With reference thereto, when the lithium secondary battery is discharged, the lithium metal or lithium alloy 212 is stripped from the outer portion of the composite, and when charged, lithium is plated on the structure 211 and thus the composite returns to the original shape thereof. When the composite according to the present disclosure is used, the growth of lithium dendrites may be suppressed, so the lifespan of the lithium secondary battery may be prolonged.

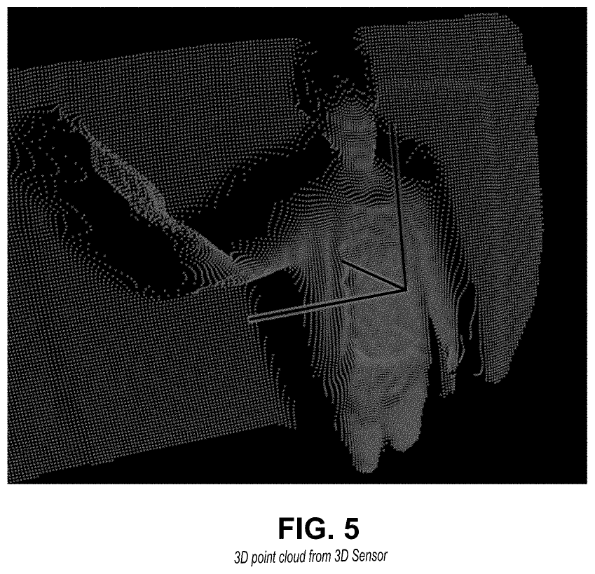

FIG. 5 shows a reference view for explaining a change in the anode 20 during charging and discharging of the lithium secondary battery. In the anode 20 according to the present disclosure, even when lithium is stripped during discharge, the structure 211 is capable of maintaining the shape thereof, as shown in FIG. 4, so the thickness h, h′ of the anode may be maintained. Specifically, since the anode 20 according to the present disclosure is not greatly affected by the volume change due to lithium plating and stripping, the safety of the lithium secondary battery is greatly improved.

The separator 30 prevents physical contact of the cathode 10 and the anode 20.

The separator 30 may consists of a porous polymer film commonly used in the art to which the present disclosure belongs, for example, a porous polymer film formed of a polyolefin-based polymer such as an ethylene homopolymer, propylene homopolymer, ethylene/butene copolymer, ethylene/hexene copolymer, ethylene/methacrylate copolymer, etc. or may be formed by stacking the same. Meanwhile, examples of the separator 30 may include, but are not limited to, typical porous nonwoven fabrics, such as nonwoven fabrics made of high-melting-point glass fibers, polyethylene terephthalate fibers, and the like.

The electrolyte is responsible for movement of lithium ions between the cathode 10 and the lithium electrode 20, and may include a lithium salt and an organic solvent.

Here, all or part of the cathode 10 and the separator 30 may be impregnated with the electrolyte.

The lithium salt is not particularly limited, but may include at least one of lithium bis(trifluoromethanesulfonyl)imide (LiTFSI), lithium bis(fluorosulfonyl)imide (LiFSI), or combinations thereof.

The concentration of the lithium salt is also not limited, but may be controlled within a range of about 0.1 to 5.0 M. Within this range, the electrolyte may have appropriate conductivity and viscosity, and lithium ions may effectively move in the lithium secondary battery according to an embodiment of the present disclosure. However, this embodiment is merely exemplary, and the present disclosure is not limited thereto.

The organic solvent may include at least one of ethylene carbonate (EC), dimethyl carbonate (DMC), 1,3-dioxolane (DOL), dimethoxyethane (DME), or combinations thereof.

The cathode 40 may include a cathode active material, a binder, a conductive material, and the like.

The cathode active material may include at least one of lithium cobalt oxide, lithium nickel cobalt manganese oxide, lithium nickel cobalt aluminum oxide, lithium iron phosphorus oxide, lithium manganese oxide, or combinations thereof. However, the cathode active material is not limited thereto, and any cathode active material available in the art may be used.

The binder serves to assist in bonding of the cathode active material and the conductive material and bonding to the current collector, and examples thereof may include polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluororubber, various copolymers, etc.

The conductive material is not particularly limited, so long as it exhibits conductivity without causing a chemical change in the battery. Examples thereof may include graphite such as natural graphite or artificial graphite, carbon-based materials such as carbon black, acetylene black, Ketjen black, channel black, furnace black, lamp black, and summer black, conductive fibers such as carbon fibers or metal fibers, metal powder such as carbon fluoride, aluminum, and nickel powder, conductive whiskers such as zinc oxide and potassium titanate, conductive metal oxides such as titanium oxide, conductive materials such as polyphenylene derivatives, and the like.

The cathode current collector 50 may be an electrically conductive plate-type substrate. The cathode current collector 50 may include aluminum foil.

A better understanding of the present disclosure may be obtained through the following example and comparative example. However, these examples are merely set forth to illustrate the present disclosure and are not to be construed as limiting the scope of the present disclosure.

### EXAMPLE

Exfoliated graphite was purchased from Angstron Materials, and graphene was synthesized therefrom through the hummer method. The synthesized graphene was dispersed in water at a rate of 1 mg/ml, after which reduced graphene oxide was prepared in a spherical form through spray drying at about 200° C.

The size of the structure thus formed ranged from about 400 nm to about 4 μm. An alloy of lithium and magnesium was heated to a temperature of 200° C. or higher and melted in an alumina crucible that was nonreactive with lithium.

The structure was also placed in the crucible and brought into contact with the lithium alloy through stirring for a sufficient time so that the structure was filled with the alloy. The structure thus obtained was rolled on a copper current collector, and an anode was manufactured so that the rolled lithium had a thickness of about 50 μm.

### Comparative Example

Lithium foil having a thickness of about 45 μm was attached to a copper current collector to obtain an anode.

### Experiment

Lithium plating was performed on the anodes according to Example and Comparative Example in the following manner.

The battery was configured to include a cathode, a separator, an electrolyte, and an anode. The cathode comprises NCM811 (having a capacity of 3 mAh/cm²) as a cathode active material. A polyethylene film coated with ceramic was used as the separator. An ether-based electrolyte was used as the electrolyte, and specifically, dimethyl ether (DME) in which a salt of 2 M LiFSI was dissolved was used.

After the battery was charged at a current density of 0.1C for 1 hour, the cell was disassembled to prepare a sample.

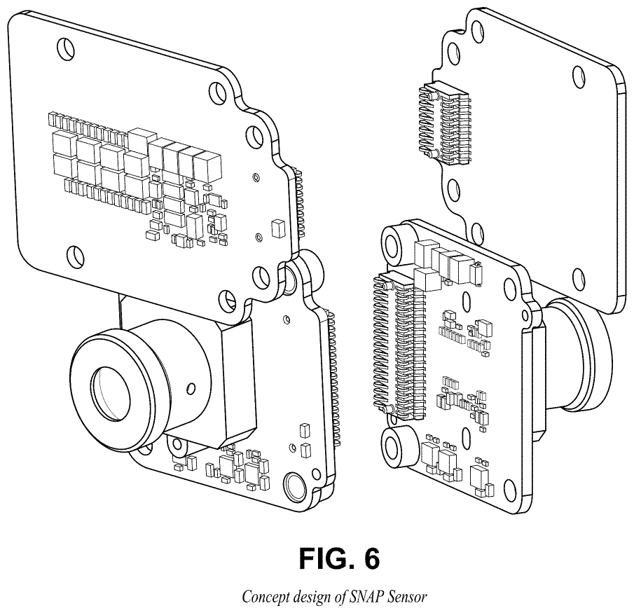

FIG. 6A shows an SEM image of the shape of lithium plated on the anode according to Example, and FIG. 6B shows an SEM image of the shape of lithium plated on the anode according to Comparative Example. With reference thereto, it can be seen that lithium was more uniformly deposited on the anode according to Example. This is deemed to be because the structure lowers the local current density in the anode and also because the lithium metal or lithium alloy evenly distributed in the anode induces lithium plating.

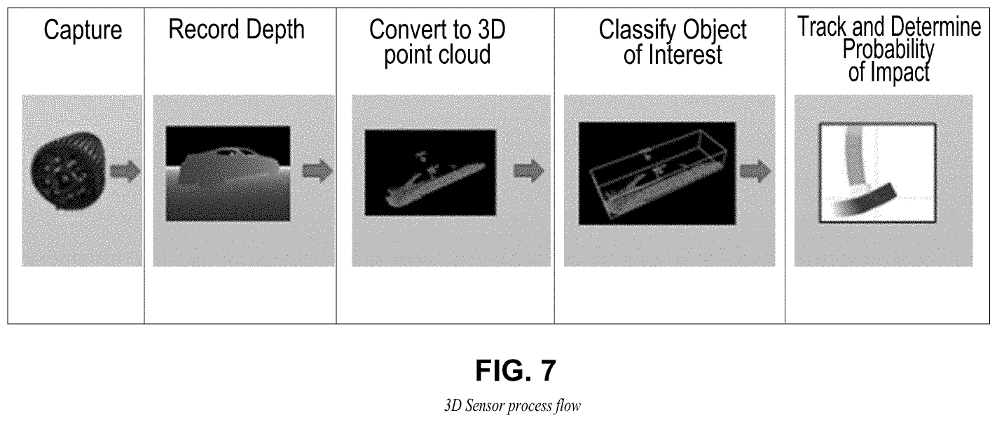

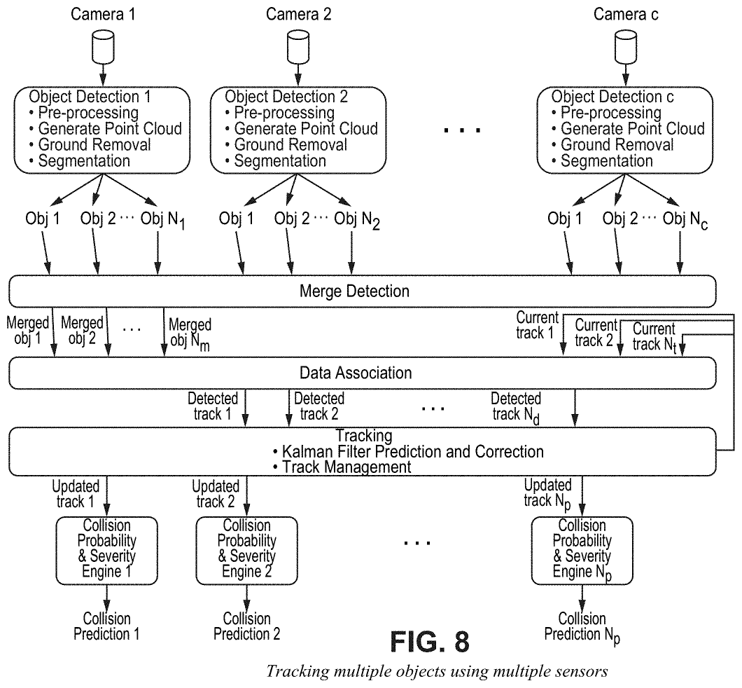

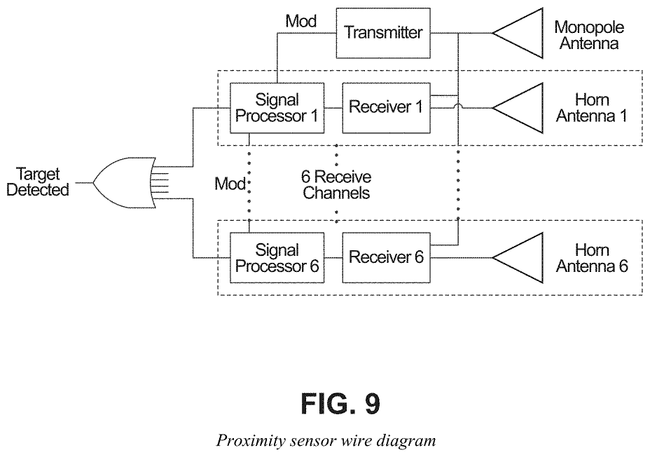

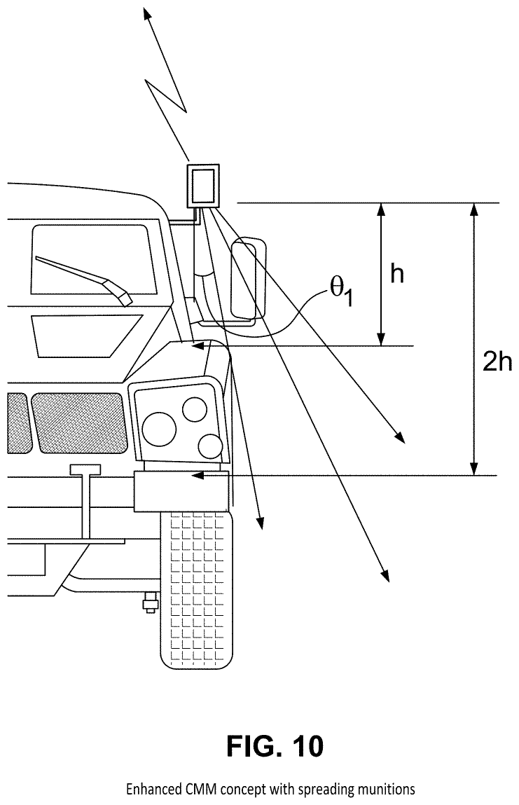

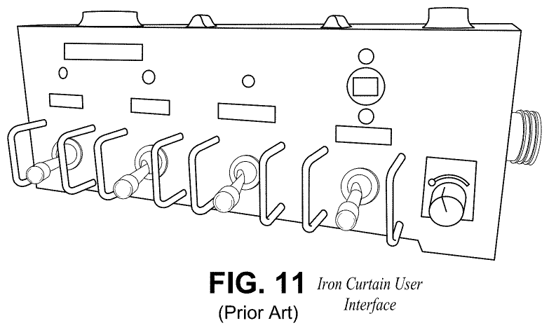

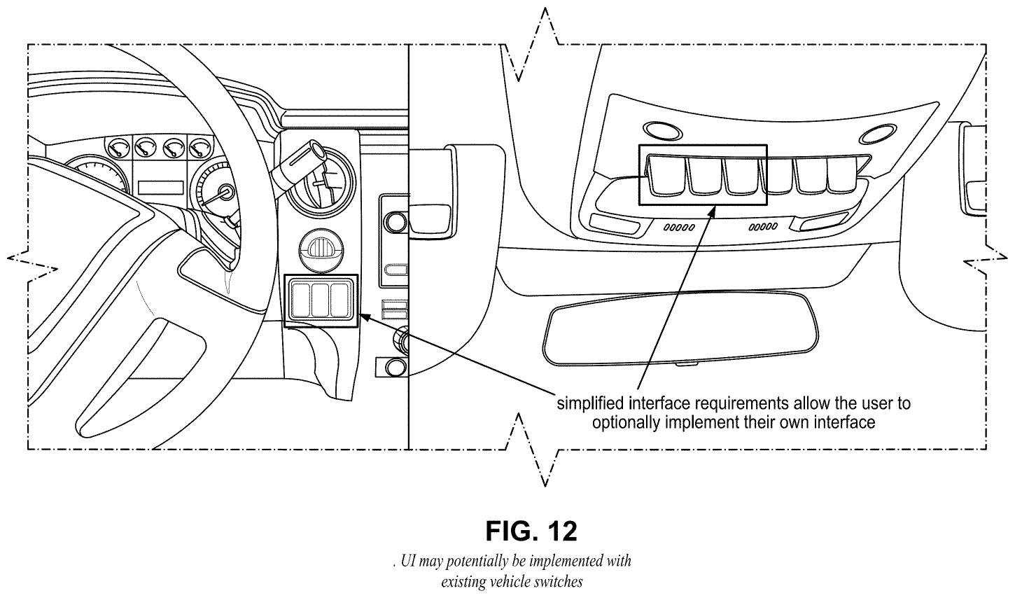

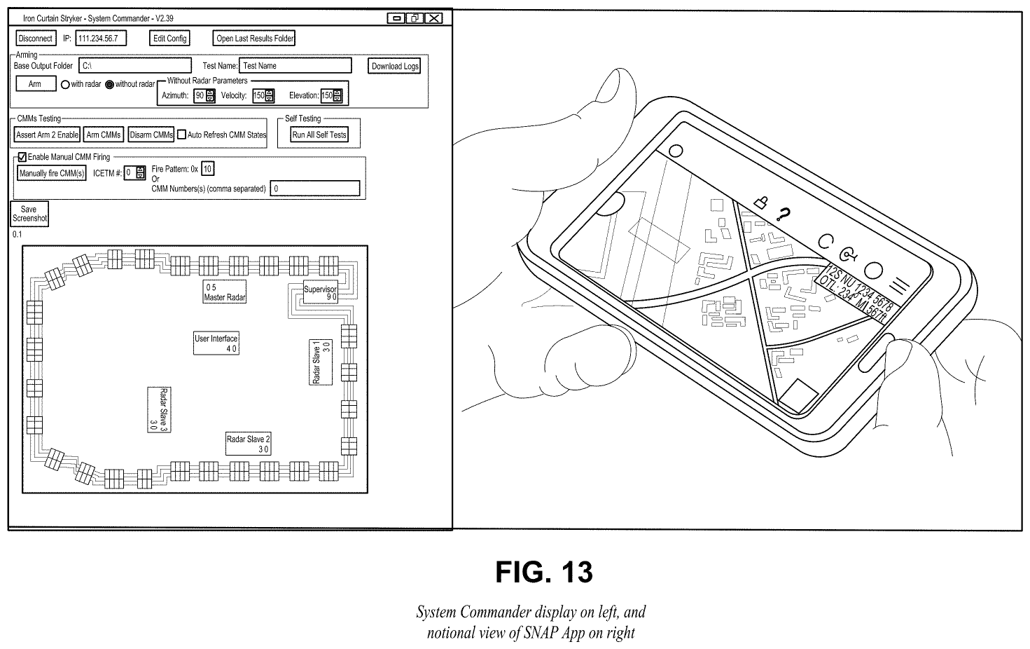

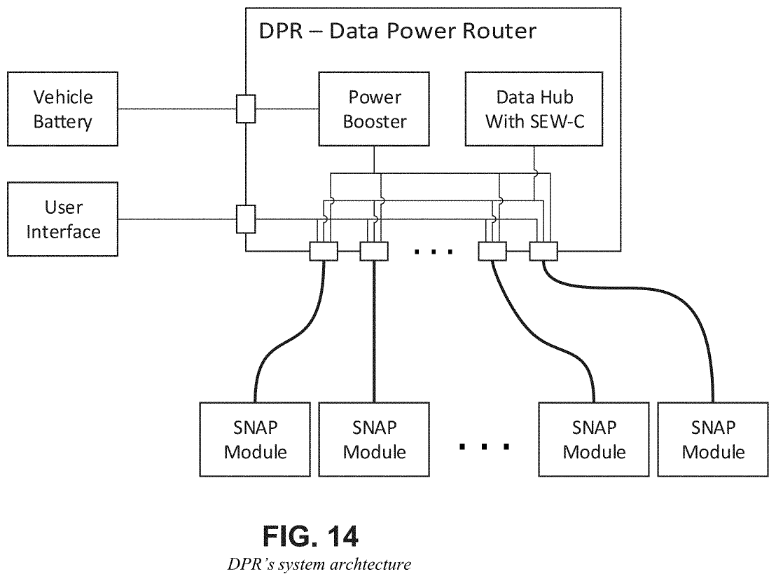

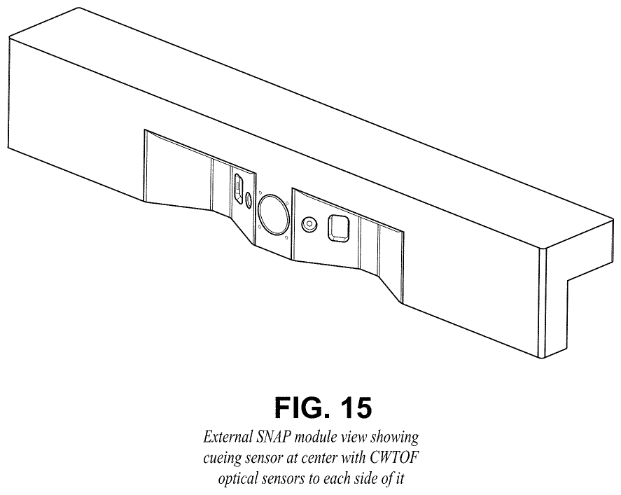

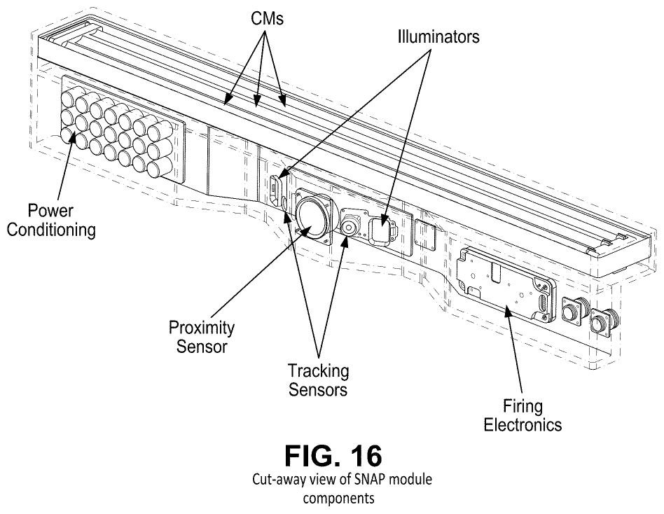

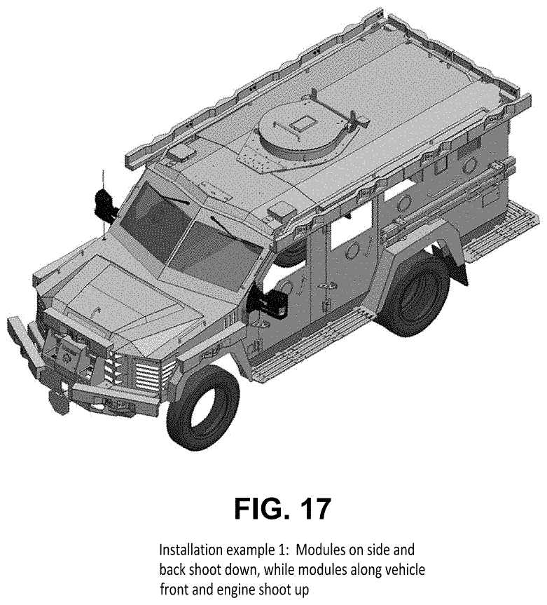

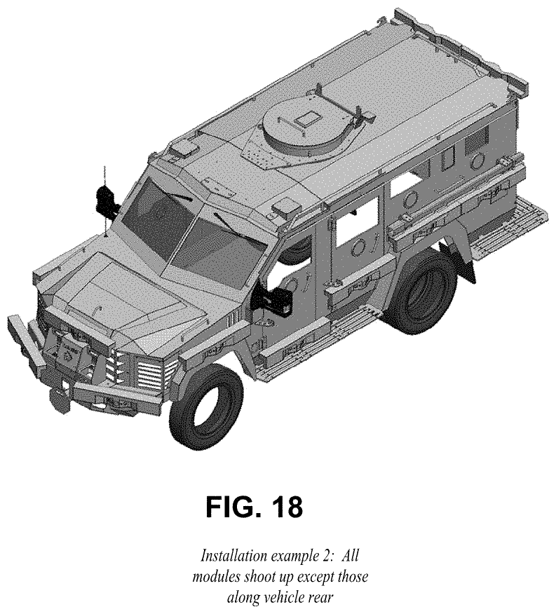

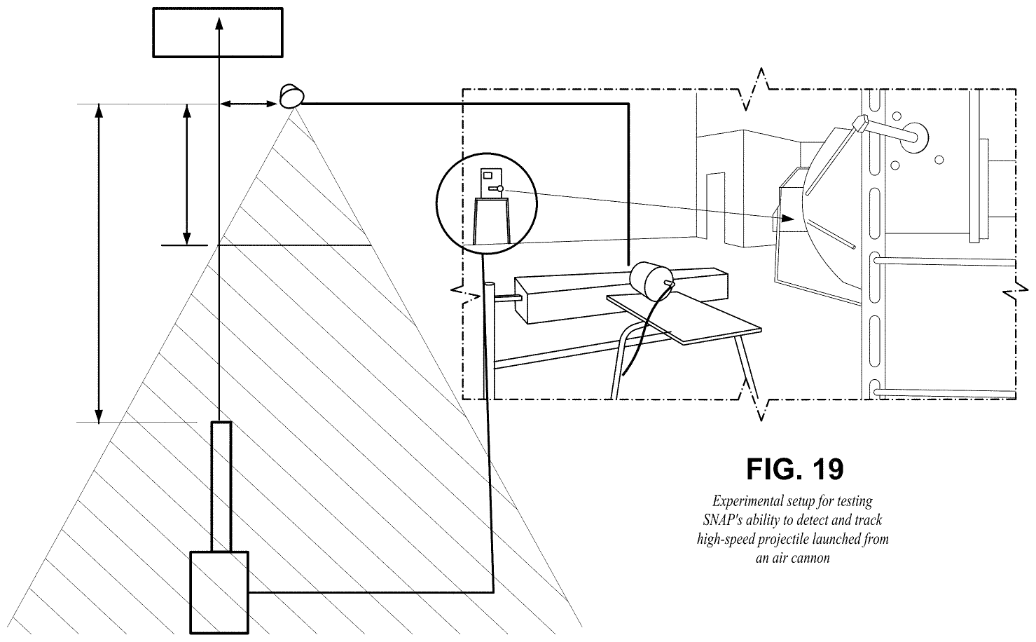

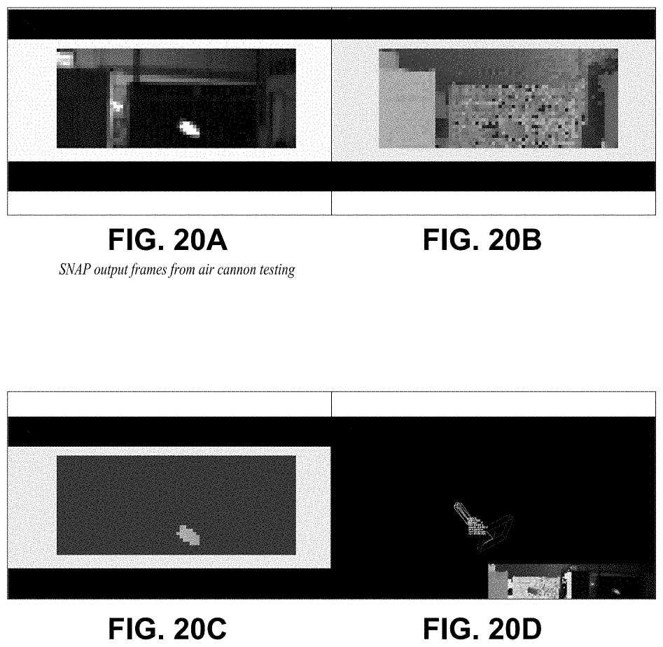

Meanwhile, battery cells including the anodes according to Example and Comparative Example were configured in the same way as above, after which the lifespan thereof was evaluated. The results thereof are shown in FIG. 7. With reference thereto, it can be seen that the battery cell according to Example exhibited a much longer lifespan than that of Comparative Example.

As is apparent from the above description, according to the present disclosure, the growth of lithium dendrites on the anode is suppressed and lithium is uniformly plated and stripped, so the lifespan and efficiency of the lithium secondary battery can be increased.

The effects of the present disclosure are not limited to the above-mentioned effects. It should be understood that the effects of the present disclosure include all effects that can be inferred from the description of the present disclosure.

Although embodiments have been described hereinbefore with reference to limited examples and drawings, various modifications and variations are possible from the above description by those skilled in the art. For example, even when the techniques described are performed in a different order than the method described and/or even when the described components are coupled or combined in a form different from the described method or are replaced or substituted by other components or equivalents, appropriate results can be achieved. Therefore, other implementations, other embodiments, and equivalents to the claims are also incorporated in the scope of the following claims.

What is claimed is:

1. An anode for a lithium secondary battery, comprising:
a composite comprising:
a structure having a predetermined shape by agglomerating a plurality of particles; and
a lithium metal or a lithium alloy filled in a space between the particles in the structure.

2. The anode of claim 1, wherein the particles comprise at least one of spherical particles, linear particles, sheet-type particles, or any combination thereof.

3. The anode of claim 1, wherein the particles comprise at least one of carbon spheres, carbon fibers, carbon nanotubes, graphene, graphene oxide, reduced graphene oxide, carbon nitride, or any combination thereof.

4. The anode of claim 1, wherein the particles comprise at least one of poly (3,4-ethylenedioxythiophene)-poly(styrenesulfonate) (PEDOT-PSS), polyacrylonitrile (PAN), poly(methyl methacrylate) (PMMA), poly(tetrafluoroethylene) (PTFE), poly(vinylidene fluoride) (PVDF), Nafion, cellulose and cellulose-based polymers, poly(ethylene oxide) (PEO), or any combination thereof.

5. The anode of claim 1, wherein a surface of the particles is substituted with a functional group, and the functional group comprises at least one of a hydroxyl group, a carboxyl group, a carbonyl group, an ester group, an amide group, a nitrile group, or any combination thereof.

6. The anode of claim 1, wherein a size of the particles ranges from about 400 nm to about 4 μm.

7. The anode of claim 1, wherein the lithium alloy comprises an alloy of lithium and at least one of magnesium (Mg), silicon (Si), tin (Sn), aluminum (Al), germanium (Ge), bismuth (Bi), antimony (Sb), or any combination thereof.

8. The anode of claim 1, wherein a size of the composite ranges from about 400 nm to about 4 μm.

9. A lithium secondary battery, comprising:
a cathode;
the anode of claim 1;
a separator interposed between the cathode and the anode; and
an electrolyte impregnated in the separator.
